(19) United States
(12) Patent Application Publication
(10) Pub. No.: US 2025/0079612 A1
(43) Pub. Date: Mar. 6, 2025

(54) CELL HOLDER FOR HOLDING BATTERY CELLS

(71) Applicant: MAHLE International GmbH, Stuttgart (DE)

(72) Inventors: Dieter Reisinger, Muehlacker (DE); Dragos-Cristian Iancu, Hitzhofen (DE); Thomas Klambach, Ostfildern (DE); Eduard Reimer, Fellbach (DE)

(21) Appl. No.: 18/820,250

(22) Filed: Aug. 29, 2024

(30) Foreign Application Priority Data
Sep. 1, 2023 (DE) 10 2023 208 438.4

(51) Int. Cl. H01M 50/249; H01M 10/6557; H01M 50/213; H01M 50/227; H01M 50/289

(52) U.S. Cl. CPC H01M 50/249; H01M 10/6557; H01M 50/213; H01M 50/227; H01M 50/289

(57) ABSTRACT

A cell holder for holding a plurality of battery cells of a traction battery may include a base body, at least two first receptacles disposed on a first side of the base body, and at least two second receptacles disposed on a second side of the base body opposite the first side. The base body may have a grid-like and one-piece construction. The base body may include a plurality of grid openings. The at least two first receptacles and the at least two second receptacles may each be configured to accommodate a single battery cell of the plurality of battery cells.

### CROSS-REFERENCE TO RELATED APPLICATION

This application claims priority to German Patent Application No. 10 2023 208 438.4, filed on Sep. 1, 2023, the contents of which is hereby incorporated by reference in its entirety.

### TECHNICAL FIELD

The present invention relates to a cell holder for accommodating battery cells of a traction battery. The invention also relates to a traction battery for a battery electric vehicle with at least one cell holder.

### BACKGROUND

A generic traction battery is known, for example, from DE 10 2020 135 014 A1 and comprises at least one battery module that has several rechargeable electrochemical battery cells. The battery module has a battery housing which has a housing interior for accommodating the battery cells and a housing base on which the battery cells are directly or indirectly supported. The battery cells are designed as cylindrical round cells such that they each have a longitudinal center axis and two end faces facing away from each other with respect to the longitudinal center axis of the cell. The battery cells are arranged in the housing interior in such a way that their longitudinal center axes run parallel to each other and perpendicular to the housing base, such that the battery cells are each supported directly or indirectly on the housing base via one of the end faces. The battery cells can be pre-assembled in individual cell holders, which are then installed together with the battery cells as a unit in the battery housing. The battery cells accommodated in the cell holder and arranged in the housing interior can be tempered by bringing them into direct thermal contact with a tempering medium flowing directly around the battery cells. By transferring heat from the battery cells to the tempering medium, they can be cooled in the sense of immersion cooling. If the battery cells are to be heated, heat can be transferred from the tempering medium to the battery cells.

### SUMMARY

It is a task of the present invention to show new ways in the development of such cell holders for accommodating battery cells of a traction battery. In particular, the aim is to create an improved design for a cell holder that requires little installation space, is technically simple and can also be manufactured cost-effectively. In addition, an improved cell holder is to be created, which is also particularly suitable for immersion cooling of the battery cells it holds.

According to the invention, this task is solved by the subject matter of the independent patent claim(s). Advantageous embodiments are the subject matter of the dependent patent claim(s).

The basic idea of the invention is therefore to realize a cell holder for accommodating several battery cells of a traction battery by means of a grid-like base body in which a plurality of grid openings are provided. This makes it possible to arrange the battery cells to be held on both sides of the base body. In this way, the cell holder requires comparatively little installation space in relation to the number of battery cells it can hold. To accommodate and hold the batteries on the cell holder, first receptacles can be provided on a first of the two sides of the base body and second receptacles can be provided on a second side opposite the first side. These receptacles are realized by a geometry of the grid-like base body, which is adapted to the geometry of the battery cells to be accommodated—typically round cells with a cylindrical geometry. The cell holder presented here therefore does not require any separate mounting elements in addition to the base body, which simplifies the design of the cell holder. A dimensionally stable, i.e., rigid, plastic is a suitable material for the base body. By using plastic as the material for the cell holder, further cost savings are achieved in the manufacture of the cell holder.

A further advantage of the cell holder according to the invention is that it can be flexibly designed to hold a certain number of battery cells by providing first and second receptacles. By providing two or more such cell holders with respective battery cells, a comparatively large number of battery cells can also be arranged in a mechanically stable manner in a battery housing of the traction battery and held there. For this purpose, the individual battery cells can first be mounted on the respective cell holder and then the cell holders with the battery cells, each as a unit, can be successively inserted into the battery housing. Mounting the individual battery cells on the cell holder is also extremely simple, as the battery cell in question only needs to be placed in the respective holder.

The grid openings in the base body allow a tempering medium to come into direct contact both mechanically and thermally with the battery cells held on the cell holder or accommodated by the cell holder, i.e., the tempering medium can flow directly around said battery cells. This ensures very good thermal contact between the battery cells and the tempering medium. The cell holder according to the invention is therefore particularly suitable for tempering and, in particular, cooling the battery cells held by means of immersion cooling. This enables a reliable flow around all battery cells, particularly in the case of immersion tempering.

The result is a technically simple cell holder that requires little installation space but can also be manufactured at low cost.

In detail, a cell holder according to the invention for accommodating battery cells of a traction battery comprises a grid-like and one-piece base body. Several, i.e., at least two, grid openings are formed in the base body. At least two first receptacles, each for accommodating a battery cell, are provided on a first side of the base body. On a second side of the base body, opposite the first side, there are at least two second receptacles, also each for accommodating a battery cell. Both the first and second receptacles can each be formed by a volume that is partially surrounded by the grid-shaped base body. The battery cell in question is positioned in the corresponding volume for accommodating in the respective receptacle.

The base body of the cell holder according to the invention can preferably consist of a plastic material or comprise such a plastic material. The plastic material particularly preferably is a dimensionally stable or rigid plastic material, such that a dimensionally stable or rigid base body is created.

In a preferred embodiment of the cell holder according to the invention, the base body has a first and a second end wall, which face each other along an axial direction of the base body and axially delimit the first and second receptacles and also the base body. The two end walls are connected to each other by means of a plurality of connecting elements of the base body, which delimit the grid openings at least in sections. Several of the connecting elements each partially delimit at least one first and/or second receptacle. The design of the base body described above makes it possible to make the base body mechanically rigid such that it is able to keep the battery cells permanently mechanically stable in long-term operation, despite the mechanical stresses that typically occur in a battery electric vehicle in the form of knocks and impacts.

It is particularly practical for the first and second receptacles to be arranged alternately one after the other along a longitudinal direction running perpendicular to the axial direction. This arrangement of the receptacles means that the cell holder with the battery cells it holds requires only a small amount of installation space. This in turn makes it possible to arrange a large number of battery cells in a battery housing of the traction battery in a space-saving manner, especially when two or more cell holders according to the invention are used.

Particularly preferably, the first and second receptacles can each be designed to partially accommodate a battery cell designed as a cylindrical round cell. As the respective battery cell is thus partially surrounded by the base body of the cell holder, it can be held in the exact position by the cell holder.

It is particularly practical for at least one connecting element to be designed as a connecting strut. By designing the connecting element as a connecting strut, the required installation space is further reduced without compromising the rigidity of the base body. In addition, by designing the connecting elements as connecting struts, the grid openings of the base body, which are essential to the invention and through which a tempering medium can come into direct contact with the battery cell in question, can be realized in a particularly simple and thus cost-effective manner.

Particularly preferably, at least one of the connecting elements or at least one of the connecting struts either extends along the axial direction or, alternatively, is arranged in a plane that is oriented perpendicular to the axial direction. Preferably, this condition applies to several of the connecting elements. A cage-like geometry of the cell holder or base body can be realized by means of such a geometry, which requires little installation space and yet ensures a stable mounting of the individual battery cells.

According to an advantageous further development of the cell holder according to the invention, at least one tolerance compensation body, preferably made of an elastic material, particularly preferably of an elastomer, can be arranged on the base body facing a respective first or second receptacle. Such a tolerance compensation body can be used to compensate for manufacturing tolerances in the cell holder, but also in the battery cells to be held. The tolerance compensation body can preferably be designed as an elastic foam body. The tolerance compensation body can be preloaded against the battery cell held in a respective first or second receptacle. The tolerance compensation body can preferably be designed in such a way that, when the respective battery cell accommodated in the respective receptacle is pressed in a normal or proper manner parallel to the longitudinal center axis of the cell, the respective elastic tolerance compensation body is elastically deformed or compressed by at least 5%, preferably by at least 10%.

Particularly preferably, at least one tolerance compensation body, facing the respective first or second receptacle, can be arranged on a connecting element or on a connecting strut. Alternatively or additionally, in this variant at least one tolerance compensation body can be arranged on the first or second end wall, facing the respective first or second receptacle. The tolerance compensation body can be easily attached to the connecting element or the end wall during the production of the cell holder or the base body, resulting in cost advantages in the production of the cell holder.

Particularly advantageously, at least one grid opening can have a rectangular or square geometry.

According to an advantageous further development of the cell holder according to the invention, a positioning structure for positioning the cell holder on the battery housing or in the housing interior of the traction battery can protrude from a side of the first end wall facing away from the second end wall. Using the positioning structure, the cell holder can be positioned precisely in the housing interior and held stably on the battery housing or in the housing interior. In particular, the positioning structure can be formed by projections that protrude from the first end wall of the base body. The positioning structure or the protrusions can be integrally formed on the first end wall, which means that the positioning structure or protrusions and the first end wall are formed in one piece and as a single material. The positioning structure can interact with a counter-positioning structure provided on the battery housing of the traction battery according to the invention, in particular on the housing base of the battery housing. The positioning structure and said counter-positioning structure can be designed to complement each other, such that when the cell holder is arranged in the battery housing and supported on the housing base, the positioning structure and the counter-positioning structure form a positive connection.

The invention also relates to a traction battery for a battery electric vehicle. The traction battery comprises at least one battery module, which in turn has several rechargeable electrochemical battery cells, each of which is designed as a cylindrical round cell. Furthermore, the battery module comprises a battery housing that at least partially surrounds a housing interior. Furthermore, the battery module comprises at least one cell holder according to the invention, as presented above, which is arranged in the housing interior and is supported on the battery housing. The advantages of the cell holder according to the invention explained above are therefore transferred to the traction battery according to the invention.

According to the invention, a battery cell of the battery module is arranged in at least one first receptacle and, alternatively or additionally, in at least one second receptacle. Preferably, one battery cell of the battery module can be arranged in each of the first and second receptacles, such that the battery cells of the traction battery are distributed over the first and second receptacles.

With the aid of the cell holder essential to the invention, said battery cells of the traction battery can be mounted in the battery housing in a simple manner, whereby a maximum number of battery cells that can be mounted in the battery housing is essentially determined by the volume of the housing interior.

A particularly advantageous feature of the traction battery according to the invention is that the individual battery cells can initially be pre-assembled on a cell holder according to the invention and, after such pre-assembly, the cell holder including the pre-assembled battery cells can be mounted as a structural unit in the battery housing of the traction battery according to the invention. This considerably simplifies the assembly of the traction battery. In this way, the traction battery according to the invention can flexibly determine how many battery cells a single cell holder should accommodate and how many cell holders with respective battery cells should in turn be accommodated by the battery housing. This provides the specialist with flexible design options.

According to another advantageous further development, at least two, preferably several, cell holders with respective battery cells can be arranged next to each other in the housing interior.

Preferably, the traction battery can be configured as an immersion-tempered traction battery, i.e., designed such that a tempering path is routed through the battery housing in such a way that a tempering medium routed in the tempering path comes into direct contact with the battery cells and can thus absorb heat from the battery cell concerned or release heat to it, depending on whether the battery cell is to be cooled or heated; because, depending on the operating state of the traction battery, it may be necessary to cool or heat the battery cells in order to optimize the performance of the traction battery. A temperature-controlled, in particular immersion-tempered, traction battery is therefore configured for tempering of the battery cells such that the battery cells can be cooled or heated as required.

In a preferred embodiment of the traction battery according to the invention, the battery cells communicate fluidically with the housing interior via the through-openings formed in the cell holder, such that tempering medium guided through the housing interior or in the tempering path can come into direct contact with the battery cells.

In another preferred embodiment, the base body in the area of the first and second receptacles can rest at least in sections against the battery cell accommodated in the respective receptacle.

In a further preferred embodiment, at least one tolerance compensation body can be preloaded against the battery cell accommodated in the relevant first or second receptacle. This ensures a particularly stable and permanent fixation of the battery cell to the battery holder, even if manufacturing tolerances are present.

In a further preferred embodiment of the traction battery according to the invention, the battery housing comprises a flat housing base and a housing wall projecting from the housing base, preferably in the form of a collar, which together partially delimit the housing interior. In this further development, the housing wall encloses a housing opening for inserting the cell holders into the housing interior. A positioning counter-structure is formed on the housing base for lateral positioning of the cell holders in the housing interior. The counter-positioning structure can preferably interact with the above-mentioned positioning structure provided on the cell holder and, in particular, form a positive connection with it. Particularly preferably, the counter-positioning structure can be complementary to the positioning structure provided on the cell holder.

The counter-positioning structure can be integrally formed on the housing base of the battery housing, which means that the counter-positioning structure or its protrusions and the housing base are formed in one piece and in the same material. To fix the respective cell holder in the battery housing, the cell holder can be placed on the housing base such that the positioning structure engages with the counter-positioning structure. The positioning structure and the counter-positioning structure can be designed to complement each other, such that the positioning structure and the counter-positioning structure form a positive connection when the cell holder is arranged in the battery housing and the cell holder is supported on the housing base.

According to an advantageous further development, the positioning counter-structure can have several projections, preferably integrally formed on the housing base, projecting from the housing base into the housing interior. This further development is particularly easy to manufacture and therefore offers cost advantages in the production of the traction battery.

Particularly preferably, at least one respective projection can be provided on the housing base for each cell holder arranged in the housing interior.

According to a further advantageous further development, the first end wall of the base body of at least one cell holder can be arranged at a distance from the housing base by means of the positioning contour. The space thus formed between the first end wall and the housing base can form a tempering channel for the tempering medium to control the temperature of the battery cells, through which the tempering medium can flow. In this way, the tempering medium can be distributed particularly evenly to the individual battery cells arranged in the housing interior, resulting in uniform tempering of the individual battery cells.

In another preferred embodiment, the battery cells, which are designed as cylindrical round cells, each have a longitudinal center axis and two end faces facing away from each other with respect to the longitudinal center axis of the cell. In this embodiment, the battery cells are arranged in the respective receptacle of the cell holder in such a way that their longitudinal center axes run essentially parallel to each other and perpendicular to the end walls of the cell holder and the battery cells are supported directly or indirectly on the two end walls at the front.

Further important features and advantages of the invention are apparent from the subclaims, from the drawings, and from the associated description of the figures with reference to the drawings.

It is understood that the above-mentioned features and those to be explained below can be used not only in the combination indicated in each case, but also in other combinations or on their own, without departing from the scope of the invention as defined by the patent claims. The above-mentioned components of a superordinate unit, such as a device, an apparatus, or an arrangement, which are designated separately, can form separate parts or components of this unit or be integral areas or sections of this unit, even if this is shown differently in the drawings.

Preferred embodiments of the invention are shown in the drawings and are explained in more detail in the following description, with identical reference signs referring to identical or similar or functionally identical components.

### BRIEF DESCRIPTION OF THE DRAWINGS

It shows, in each case schematically,

FIG. 1 shows an isometric view of a traction battery with several battery modules stacked together and a dismantled battery module in an isometric exploded view,

FIG. 2a shows an isometric view of a battery module, only partially shown, with a cell holder according to the invention, with battery cells accommodated therein and with a battery housing for accommodating the cell holders with their battery cells,

FIG. 2b shows an exploded view of the battery module shown in part in FIG. 2a,

FIGS. 3a and 3b show an isometric representation of an example of a cell holder according to the invention,

FIG. 4a shows a top view of the battery housing,

FIG. 4b shows the housing base of FIG. 4a and the position of the first end walls of the cell holders arranged in the housing interior and supported on the housing base.

### DETAILED DESCRIPTION

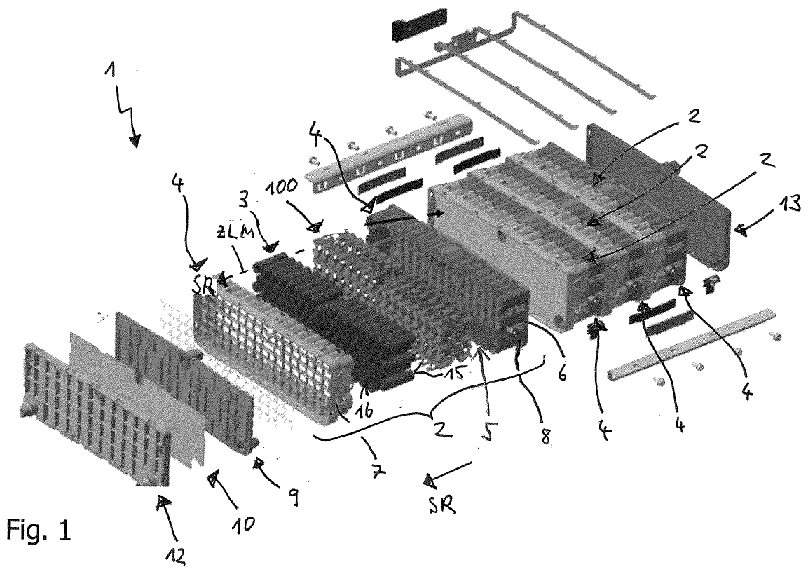

According to FIG. 1, a traction battery 1 configured for a battery electric vehicle comprises at least one battery module 2 having a plurality of rechargeable electrochemical battery cells 3. FIG. 1 shows a traction battery 1 with four such battery modules 2, whereby the three battery modules 2 shown on the right are shown in an assembled state and mounted or stacked together. In contrast, the fourth battery module 2 shown on the left is shown pulled apart such that the individual components are recognizable.

The respective battery module 2 has a battery housing 4, which has a housing interior 5 for accommodating the battery cells 3 and a housing base 6. The battery cells 3 are indirectly supported on the housing base 6. The respective battery housing 4 also has a housing cover 7, which is also designed to be flat and lies perpendicular to the housing base 6 opposite the housing base 6. In addition, the battery housing 4 has a housing wall 8, which in the example shown here is integrally formed partly on the housing base 6 and partly on the housing cover 7. The housing wall 8 runs around the housing interior 5 and thus around the battery cells 3 housed in it. A fluid distribution plate 9 and an intermediate plate 10 can be arranged between adjacent battery modules 2. The battery modules 2 are stacked on top of each other along a stacking direction SR (Stapelrichtung [stacking direction]). With regard to the stacking direction SR, there is a front end plate 12 and a rear end plate 13 at the longitudinal ends of the traction battery 1. Conveniently, the traction battery 1 is configured as an immersion-tempered traction battery 1, such that a corresponding dielectric tempering medium, in particular a dielectric fluid, can be supplied and discharged via corresponding connections, which are recognizable, for example, on the rear end plate 13. The fluid distribution plates 9 support a targeted flow through the housing interiors 5 of the battery modules 4 of the traction battery 1, whereby the battery cells 3 come into direct contact with the tempering medium.

FIG. 1 shows further peripheral components of the traction battery 1, which are not described in detail and can be used, for example, for electrical contacting, fluid distribution, and for attaching the battery modules 2 to each other. The individual battery modules 2 or their battery housings 4 can be appropriately configured in a cuboid shape. In the present context, the term “configuration” is synonymous with the term “arrangement”, such that the phrase “configured such that” is synonymous with the phrase “arranged such that”.

The battery cells 3 are configured in the present case as cylindrical, in particular circular-cylindrical, round cells, each of which has a longitudinal center axis ZLM (Zellenlängsmittelachse [longitudinal center axis]) and two end faces 15 and 16 that face away from each other with respect to the longitudinal center axis ZLM. Furthermore, the battery cells 3 are arranged in the housing interior 5 in such a way that their longitudinal center axes ZLM run parallel to each other and perpendicular to the flat housing base 6. Electrical contact is then usually made with the battery cells 3 on the other or second end face 16, although this is not shown in detail.

As shown in FIG. 1, it is noteworthy that the stacking direction SR, in which the battery modules 2 are attached to one another, runs parallel to the longitudinal center axes ZLM of the battery cells 3. When installed, the traction battery 1 is preferably mounted on the vehicle in such a way that the stacking direction SR extends essentially horizontally, resulting in a horizontal arrangement for the battery cells 3 in the operational traction battery 1 or in the vehicle.

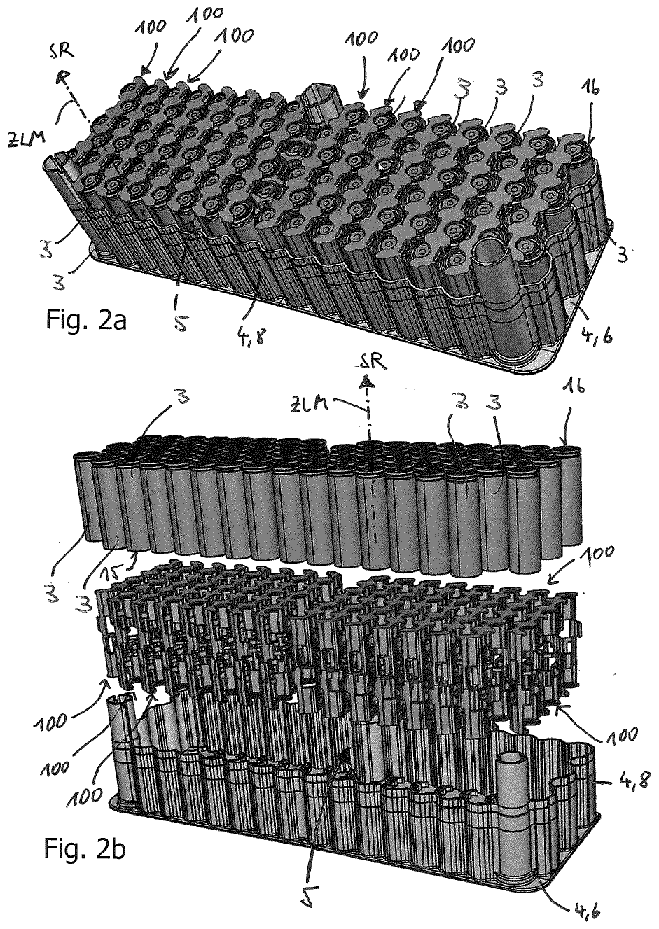

In order to improve the predetermined positioning of the battery cells 3 within the interior 5 of the battery housing 4, a plurality of cell holders 100 according to the invention are used in FIG. 1, each of which interacts with a plurality of battery cells 3 in order to position and hold them in the battery housing 4. FIGS. 2a and 2b illustrate this scenario. FIG. 2a shows a battery housing 4 without a housing cover 7 with several cell holders 100 arranged therein in an isometric view. FIG. 2b is an exploded view of FIG. 2a. The cell holders 100 arranged in the housing interior 5 are each supported on the battery housing.

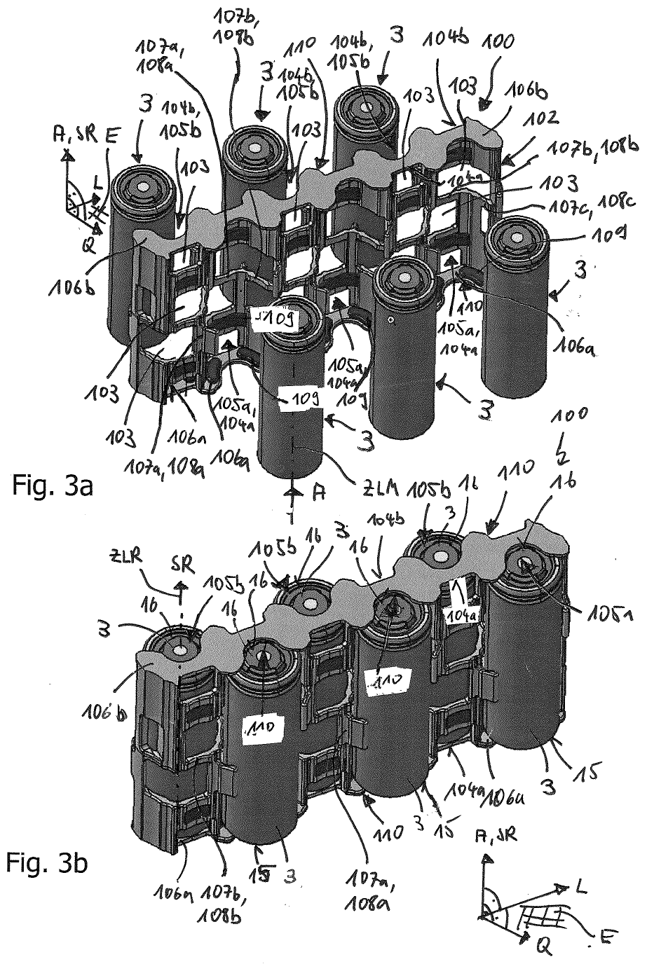

FIGS. 3a and 3b show an isometric representation of an example of an individual cell holder 100 shown in FIGS. 2a and 2b for accommodating the battery cells 3. FIG. 3a shows the battery cells 3 to be accommodated at a distance from the cell holder 3, FIG. 3b in a state accommodated on the cell holder 100.

The cell holder 100 comprises a base body 102 that is formed in one piece in the form of a grid. Several grid openings 103 are formed in the base body 102. The base body 102 may consist of or comprise a plastic material. Three first receptacles 105a are formed on a first side 104a of the base body 102 to accommodate three battery cells 3. On a second side 105a of the base body 102 opposite the first side 104a, three second receptacles 105b are provided for accommodating three further battery cells 3. The cell holder 100 shown can therefore hold six battery cells 3, which are also shown in FIG. 3a, but are shown at a distance from the cell holder 100 to illustrate its structure. In variants of the example, a different number of first or second receptacles 105a, 105b can also be provided. The individual first and second receptacles 105a, 105b can each be designed to partially accommodate the individual battery cells 3, which are each designed as cylindrical round cells, and can be adapted to the cylindrical geometry of the battery cells 3 for this purpose.

According to FIGS. 3a and 3b, the battery cells 3 of the cell holder 100 are distributed over the first and second receptacles 105a, 105b, i.e., each of the battery cells 3 is accommodated or arranged either in one of the first receptacles 105a or in one of the second receptacles 105b.

In the region of the first and second receptacles 105a, 105b, the base body 102 can rest at least in sections against the battery cell 3 accommodated in the respective receptacle 105a, 105b.

According to FIGS. 3a and 3b, the base body 102 further comprises a first and a second end wall 106a, 106b, which are opposite each other along an axial direction A of the base body 102. The two end walls 106a, 106b axially delimit the first receptacles 105a and second receptacles 105b and also the entire base body 102. The two end walls 106a, 106b can—when viewed in a plan view along the axial direction A—have wave-shaped contours 110.

As FIG. 3a shows, the existing first and second receptacles 105a, 105b are arranged in alternating succession along a longitudinal direction L running perpendicular to the axial direction A. The first receptacles 105a and the second receptacles 105b are located opposite one another along a transverse direction Q, which extends perpendicular to both the axial direction A and the longitudinal direction L.

In a state accommodated in the first or second receptacle 105a, 105b, the battery cell 3 in question is supported with its end face 15 directly or indirectly on the first end wall 106a and with its end face 16 directly or indirectly on the second end wall 106b (cf. FIGS. 3a, 3b), or vice versa. The individual battery cells 3 are arranged in the respective first or second receptacle 105a, 105b of the cell holder 1 in such a way that their longitudinal center axes ZLM run essentially parallel to each other and perpendicular to the two end walls 106a, 106b of the cell holder 1.

The two end walls 106a, 106b are connected to one another by means of a plurality of connecting elements 107a, 107b, 107c of the base body, which each delimit the grid openings 103 at least in sections. Each of the connecting elements 107a, 107b, 107c also partially delimits at least one first or second receptacle 105a, 105b. The connecting elements 107a, 107b, 107c and the two end walls 106a, 106b are integrally molded to each other, i.e., they are formed in one piece and of a single material. Individual, several or all of the connecting elements 107a, 107b, 107c can each be designed as a connecting strut 108a, 108b, 108c. The grid openings 103 can each have a rectangular or square geometry.

As can be seen from the figures, first connecting elements 107a, 107b, 107c or first connecting struts 108a, 108b, 108c extend along the axial direction A. Furthermore, second connecting elements 107b or second connecting struts 108b extend along the longitudinal direction L and third connecting elements 107c or third connecting struts 108c extend along the transverse direction Q. The second and third connecting elements 107b, 107c or the second and third connecting struts 108b, 108c are thus arranged in a plane E spanned by the longitudinal direction L and by the transverse direction Q, which extends orthogonally to the axial direction A.

Tolerance compensation bodies 109 can be arranged on the base body 102 facing the respective first and second receptacles 105a, 105b.

The tolerance compensation bodies 109 can be arranged, facing the respective first or second receptacle 105a, 105b, on a connecting element 107a, 107b, 107c or on a connecting strut 108a, 108b, 108c or on one of the two end walls 106a, 106b. The tolerance compensation bodies 109 can consist of an elastic material, for example an elastomer, or be designed as an elastic foam body. In this way, the tolerance compensation bodies 109 can be preloaded against the battery cell 3 accommodated in the respective first or second receptacle 105a, 105b. The design of the tolerance compensation body 109 is such that when the respective battery cell 5 accommodated in the respective receptacle 105a, 105b is pressed in a conventional or proper manner parallel to the longitudinal center axis ZLM of the cell, the respective elastic tolerance compensation body 109 is elastically deformed or compressed by at least 10%.

As already explained with reference to FIGS. 2a and 2b, the cell holders 100 together with the battery cells 3 accommodated by the respective cell holder 100 are arranged in the housing interior 5 bounded by the battery housing 4 and are supported in this state on the housing base 6 of the battery housing. The battery cells 3 arranged in the battery housing 4 by means of a respective cell holder 100 communicate fluidically with the housing interior 5 via the through-openings 103 formed in the cell holder 100, such that the tempering medium guided through the housing interior can come into direct contact with the battery cells 3.

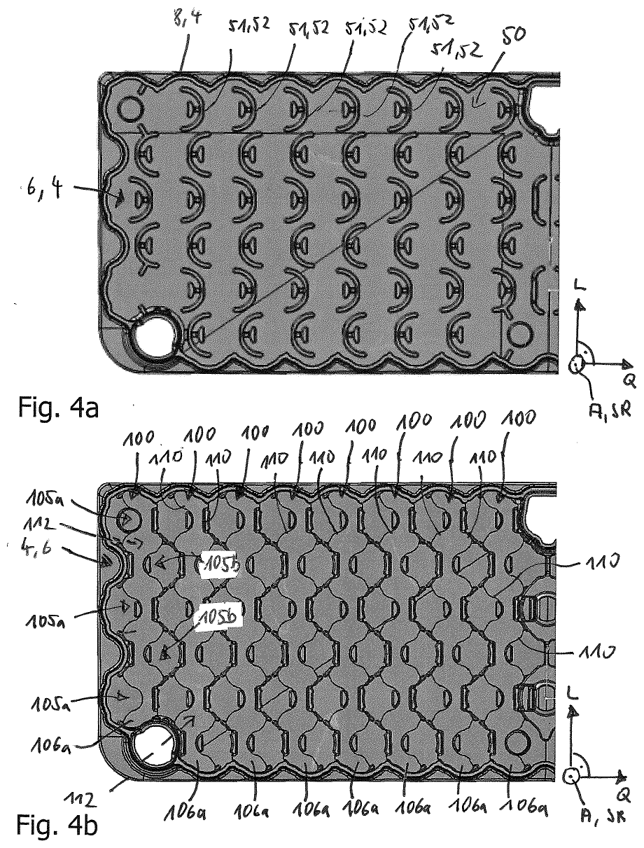

FIG. 4a shows the battery housing 4 in a top view of the housing base 6 along the axial direction A or the stacking direction SR. As illustrated in FIG. 4a and already mentioned in connection with FIG. 1, the battery housing 4 has a flat housing base 6 and a collar-like housing wall 8 projecting from the housing base 6, which together partially delimit the housing interior 5. The housing wall 8 encloses a housing opening 50 for inserting the cell holders 100 into the housing interior 5. A positioning counter-structure 51 is formed on the housing base 6 for laterally positioning the individual cell holders 100 in the housing interior.

The positioning counter-structure 51 can have several projections 52 integrally formed on the housing base 6 and projecting from this into the housing interior 5. In the example scenario, for each cell holder 100 arranged in the housing interior 5, several projections 52 are provided on the housing base 6, arranged next to one another, i.e., in succession.

FIG. 4b shows the housing base 6 of FIG. 4a and the position of the first end walls 106a of the cell holders 100 arranged in the housing interior 5 and supported on the housing base 6. Accordingly, the positioning counter-structure 51 may be complementary to a positioning contour 112 provided on the respective cell holder 100, which projects from a side of the first end wall 106a facing away from the second end wall 106b. By means of the positioning structure 112 and the positioning counter-structure 51, the cell holder 100 can be positioned precisely in the housing interior 5 and held stably on the battery housing 4 or in the housing interior 5. The positioning structure 112 provided on the first end wall 106a can also be formed by corresponding protrusions (not shown), which then have a geometry complementary to the protrusions 52 of the positioning counter-structure 51. The positioning structure 112 and the positioning counter-structure 51 or their projections thus form a positive connection, which ensures precise and reliable positioning of the cell holder 100 in the housing interior 5. By means of the positioning structure 112 and the positioning counter-structure 51, the first end wall 106a of the cell holder 100 can also be arranged at a distance from the housing base 6 of the battery housing 4, such that a gap formed between the housing base 6 of the battery housing 4 and the first end wall 106a of the cell holder 1 can be flowed through by the tempering medium.

1. A cell holder for holding a plurality of battery cells of a traction battery, comprising:
a base body having a grid-like and one-piece construction, the base body including a plurality of grid openings;
at least two first receptacles disposed on a first side of the base body; and
at least two second receptacles disposed on a second side of the base body opposite the first side;
wherein the at least two first receptacles and the at least two second receptacles are each configured to accommodate a single battery cell of the plurality of battery cells.

2. The cell holder according to claim 1, wherein:
the base body further includes a first end wall and a second end wall disposed opposite one another along an axial direction of the base body, the first end wall and the second end wall axially delimiting the at least two first receptacles and the at least two second receptacles;
the base body further includes a plurality of connecting elements via which the first end wall and the second end wall are connected to one another;
the plurality of connecting elements delimit the plurality of grid openings at least in sections; and
each connecting element of the plurality of connecting elements partially delimits at least one of i) at least one first receptacle of the at least two first receptacles and ii) at least one second receptacle of the at least two second receptacles.

3. The cell holder according to claim 2, wherein the at least two first receptacles and the at least two second receptacles are arranged following one another alternately along a longitudinal direction extending perpendicular to the axial direction.

4. The cell holder according to claim 2, wherein the at least two first receptacles and the at least two second receptacles are each configured to partially accommodate a cylindrical round battery cell.

5. The cell holder according to claim 2, wherein at least one connecting element of the plurality of connecting elements is configured as a connecting strut.

6. The cell holder according to claim 2, wherein at least one of the plurality of connecting elements at least one of i) extends along the axial direction and ii) is arranged in a plane oriented perpendicular to the axial direction.

7. The cell holder according to claim 2, further comprising at least one tolerance compensation body arranged on the base body facing a respective receptacle of one of the at least two first receptacles and the at least two second receptacles.

8. The cell holder according to claim 7, wherein the at least one tolerance compensation body is arranged on at least one of i) a connecting element of the plurality of connecting elements, ii) the first end wall, and iii) the second end wall.

9. The cell holder according to claim 1, wherein at least one grid opening of the plurality of grid openings has at least one of a rectangular geometry and a square geometry.

10. The cell holder according to claim 2, further comprising a positioning structure for positioning the cell holder at least one of on a battery housing and in a housing interior, the positioning structure protruding from a side of the first end wall facing away from the second end wall.

11. A traction battery for a battery electric vehicle, comprising at least one battery module (including:
a plurality of rechargeable electrochemical battery cells, each of which is configured as a cylindrical round cell;
a battery housing surrounding a housing interior through which a tempering medium is flowable; and
at least one cell holder according to claim 1 arranged in the housing interior and supported on the battery housing;
wherein a battery cell of the plurality of battery cells is arranged in at least one of a first receptacle of the at least two first receptacles and a second receptacle of the at least two second receptacles of the at least one cell holder.

12. The traction battery according to claim 11, wherein the at least one cell holder includes at least two cell holders with respective battery cells of the plurality of battery cells, the at least two cell holders arranged next to each other in the housing interior.

13. The traction battery according to claim 11, wherein the plurality of battery cells communicate fluidically with the housing interior via the plurality of grid openings of the at least one cell holder such that the tempering medium guided through the housing interior directly contacts the plurality of battery cells.

14. The traction battery according to claim 11, wherein the base body, in a region of the at least two first receptacles and the at least two second receptacles, bears at least in sections against a battery cell of the plurality of battery cells accommodated in a respective receptacle of one of the at least two first receptacles and the at least two second receptacles.

15. The traction battery according to claim 11, wherein the at least one cell holder further includes at least one tolerance compensation body arranged on the base body facing a respective receptacle of one of the at least two first receptacles and the at least two second receptacles and prestressed against a battery cell of the plurality of battery cells accommodated in the respective receptacle.

16. The traction battery according to claim 11, wherein:
the battery housing includes a housing base and a collar-like housing wall projecting from the housing base, which together partially delimit the housing interior;
the housing wall encloses a housing opening via which the at least one cell holder is insertable into the housing interior; and
a positioning counter-structure is arranged on the housing base for laterally positioning the at least one cell holder in the housing interior, the positioning counter-structure configured in a complementary manner to a positioning contour arranged on the at least one cell holder.

17. The traction battery according to claim 16, wherein the positioning counter-structure includes a plurality of projections and projecting from the housing base into the housing interior.

18. The traction battery according to claim 17, wherein:
the at least one cell holder includes a plurality of cell holders; and
the plurality of projections includes a respective projection for each cell holder of the plurality of cell holders arranged in the housing interior.

19. The traction battery according to claim 16, wherein:
the base body of the at least one cell holder further includes a first end wall and a second end wall disposed opposite one another along an axial direction of the base body, the first end wall and the second end wall axially delimiting the at least two first receptacles and the at least two second receptacles;
the positioning contour protrudes from a side of the first end wall facing away from the second end wall; and
the first end wall of the at least one cell holder is arranged at a distance from the housing base via the positioning contour.

20. The traction battery according to claim 11, wherein:
the base body of the at least one cell holder further includes a first end wall and a second end wall disposed opposite one another along an axial direction of the base body, the first end wall and the second end wall axially delimiting the at least two first receptacles and the at least two second receptacles;
the plurality of battery cells each have a longitudinal center axis and two end faces facing away from each other with respect to the longitudinal center axis; and
the plurality of battery cells are each arranged in a respective receptacle of one of the at least two first receptacles and the at least two second receptacles such that the longitudinal center axes of the plurality of battery cells extend parallel to one another and perpendicular to the first end wall and the second end wall and the plurality of battery cells are supported at least one of directly and indirectly on the first end wall and the second end wall at a front.
